(19) United States
(12) Patent Application Publication
(10) Pub. No.: US 2023/0056037 A1
(43) Pub. Date: Feb. 23, 2023

(54) MOBILE CEMENT BATCH MIXING PLANT

(71) Applicants: Matthew Rone, Midland, TX (US); John Couch, Midland, OK (US); Rocky Vines, Midland, TX (US)

(72) Inventors: Matthew Rone, Midland, TX (US); John Couch, Midland, OK (US); Rocky Vines, Midland, TX (US)

(73) Assignee: Legion P&ATools, LLC, Midland, TX (US)

(21) Appl. No.: 17/542,280

(22) Filed: Dec. 3, 2021

Related U.S. Application Data
(60) Provisional application No. 63/120,855, filed on Dec. 3, 2020.

(51) Int. Cl. B28C 5/06; B28C 9/04; B28C 7/02

(52) U.S. Cl. CPC B28C 5/06; B28C 9/0454; B28C 7/024

(57) ABSTRACT

A mobile cement batch mixing plant includes at least one slurry tank, a cement storage tank, at least one slurry pump and at least one clean pump supported on a transportable frame. The slurry tanks and cement storage tank are connected by a plumbing system. The flow of water and cement slurry between the tanks and within the plumbing system is controlled by a series of valves and pump controls. A cement slurry is formed by adding water and cement to the slurry tank through a fluid vortex within the slurry tank. The cement slurry can be pumped out of the slurry tank into a well.

### RELATED APPLICATIONS

The present application claims the benefit of U.S. Provisional Patent Application Ser. No. 63/120,855 filed Dec. 3, 2020 entitled “Mobile Cement Batch Mixing Plant,” the disclosure of which is fully incorporated herein as if set forth in its entireties within the present application.

### FIELD OF THE INVENTION

This invention relates generally to the field of hydrocarbon production wells, and more particularly, but not by way of limitation, to systems for the production of cement slurries to be deployed within hydrocarbon wellbores.

### BACKGROUND

Hydrocarbons, such as oil and gas, may be recovered from various types of subsurface geological formations. Oil and gas are accessed through a well which is typically drilled from the surface to the producing formation. Cement slurries may be deployed within a wellbore to provide structural support to the wellbore or to seal off the wellbore from the formation. When production of hydrocarbons from the well has slowed or stopped, usually after either well logs determine there is insufficient hydrocarbon potential to complete the well, or after production operations have drained the reservoir, a cement plug can be prepared to close the well. During the well closing process, cement plugs may be placed across any open hydrocarbon-bearing formations, across all casing shoes, across freshwater aquifers, or at areas near the surface, such as the top 20 to 50 feet of the wellbore.

In some instances, bridge plugs may be used in conjunction with cement slurries to ensure that higher density cement does not fall into the wellbore. Where bridge plugs are used, the bridge plug is set, and cement is pumped on top of the plug through drill pipe withdrawn before the slurry thickens.

Cement plugs used to close the wellbore are generally mixed by utilizing million dollars of large permanent cementing pumps and dry bulk trucks to mix large batches of cement slurries “on the fly.” The cement pumps draw in water at a prescribed weight, and the dry bulk trucks blows off powder cement to combine and mix the water and powder cement. Conventional mixers may use a nozzle and a discharge line connected to a Venturi tube to introduce cement powder via a vacuum into the product flow for mixing. The conventional methods have small margins for error for the rates at which the water and dry bulk are combined, and take a considerable amount of time to complete the mixing process. Errors in the mixing process can lead to costly delays and large amounts of wasted product due to larger batch size. If there are variations in the rates at which the water and dry bulk are added in the process, a cement slurry with an improper density can be produced causing job failure. In addition, after the mixing process is complete, conventional methods require a tank and agitator panel to prevent setting of the cement slurry. An improper cement slurry density and job failure can also result from a malfunction in the cement pump or the dry bulk truck which cause variations in the flow rates for the components.

There is, therefore, a need for an improved smaller and transportable cement slurry mixing system which has a larger margin of error to prevent waste and save production time. It is to these and other objectives that the present invention is directed.

### SUMMARY OF THE INVENTION

In one aspect, embodiments disclosed herein include a mobile cement batch mixing plant having at least one slurry tank, at least one cement storage tank, at least one slurry pump, and at least one clean pump supported on a frame. The slurry tanks and cement storage tank are connected by a plumbing system. The flow of water and cement slurry between the tanks and within the plumbing system is controlled by a series of valves and pump controls. A cement slurry is formed by adding water to the at least one slurry tank and recirculating the water to create a fluid vortex within the at least one slurry tank. After the water vortex is formed, dry cement is disbursed into the at least one slurry tank with the water to create a cement slurry.

The input ports from the plumbing system into the at least one slurry tank may be angled to ensure that liquid (water and cement slurry) enters the side of the slurry tank to induce the flow of fluid along the interior wall of the mixing tank. Pumps may be used to pump the liquids through the recirculation system and may be adjusted to a specific velocity to cause the liquids to circulate in the interior of the at least one slurry tank at a high velocity. The ports at the bottom of the at least one slurry tank are also angled to incorporate the angle of flow and velocity down into the suction side of the pumping and back over to the pump.

The clean (water) side plumbing and dirty (slurry) side plumbing system are isolated by valves in the plumbing system and the plumbing system is used to recirculate the cement slurry though the plumbing system and back into the at least one slurry tank. The recirculation of the cement slurry maintains the vortex in the slurry tank, preventing the cement from setting until an operator is ready to deploy the cement slurry.

In another aspect, embodiment disclosed herein include a method for mixing a cement slurry with a mobile cement batch mixing plant. The method includes the step of pumping water to a cylindrical slurry tank that includes a cylindrical upper portion, a conical lower portion, and a closed top that together define a slurry tank interior. The method may also include recirculating the water from the conical lower portion, through a recirculation pump, and into the cylindrical upper portion through a tangential nozzle in the cylindrical upper portion to induce a vortex within the slurry tank interior. The method also may include adding a continuous stream of a powdered cement from the closed top into the vortex within the slurry tank interior to create a cement slurry and recirculating the cement slurry from the conical lower portion, through a recirculation pump, and into the cylindrical upper portion. Recirculating the cement slurry maintains the vortex within the slurry tank while the powdered cement is being added and the cement slurry is recirculating. Finally, a density of the recirculating cement slurry is measured while the powdered cement is being added until a desired density of the cement slurry is reached.

### BRIEF DESCRIPTION OF THE DRAWINGS

FIG. 1 depicts a perspective view of a mobile cement batch mixing plant constructed in accordance with a first embodiment.

FIG. 2 is a second perspective view of the mobile cement batch mixing plant of FIG. 1.

FIG. 3 is a plumbing synopsis of a mobile cement batch mixing plant constructed in accordance with the embodiment of FIG. 1.

FIG. 4 is the plumbing system of a mobile cement batch mixing plant independent of the mobile cement batch mixing plant constructed in accordance with an embodiment of the present invention.

FIG. 5 is a slurry tank plumbing system independent of the mobile cement batch mixing plant constructed in accordance with an embodiment of the present invention.

FIG. 6 is a slurry tank and attached slurry tank plumbing system with a fluid vortex induced by recirculation of a fluid slurry.

FIG. 7 is a process for mixing a cement slurry with a mobile cement batch mixing plant constructed in accordance with an embodiment of the present invention.

FIG. 8 is a perspective view of a mobile cement batch mixing plant constructed in accordance with a second embodiment.

FIG. 9 is a second perspective view of the mobile cement batch mixing plant of FIG. 8.

FIG. 10 is an exemplary depiction of a control unit.

FIG. 11 is a plumbing synopsis of a mobile cement batch mixing plant constructed in accordance with an embodiment of FIG. 8.

FIG. 12 is a slurry tank and attached slurry tank plumbing system with a fluid vortex induced by recirculation of a fluid slurry.

FIG. 13 is an exemplary depiction of a dispersing cone.

FIG. 14 is a plumbing synopsis of a mobile cement batch mixing plant constructed in accordance with an embodiment of FIG. 8.

FIG. 15 is a process for mixing a cement slurry with a mobile cement batch mixing plant constructed in accordance with an embodiment of the present invention.

### WRITTEN DESCRIPTION

Before explaining at least one embodiment of the inventive concepts disclosed, it is to be understood that the inventive concepts are not limited in their application to the details of construction and the arrangement of the components or steps or methodologies in the following description or illustrated in the drawings. The inventive concepts disclosed are capable of other embodiments or of being practiced or carried out in various ways. Also, it is to be understood that the phraseology and terminology employed is for description only and should not be regarded as limiting the inventive concepts disclosed and claimed herein.

In this detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features may not be described to avoid unnecessarily complicating the disclosure.

Further, unless stated to the contrary, “or” refers to an inclusive “or” and not to an exclusive “or.” For example, a condition A or B is satisfied by anyone of: A is true (or present) and B is false (or not present), A is false (or not present) and B is true (or present), and both A and B are true (or present). In addition, use of the “a” or “an” are employed to describe elements and components of the embodiments herein. This is done merely for convenience and to give a general sense of the inventive concepts disclosed. This description should be read to include one, or at least one, and the singular also includes the plural unless it is obvious that it is meant otherwise. As used herein any reference to “one embodiment” or “an embodiment” means that a particular element, feature, structure, or characteristic described in the embodiment is included in at least one embodiment. The appearances of the phrase “in one embodiment” in various places in the specification are not necessarily all referring to the same embodiment.

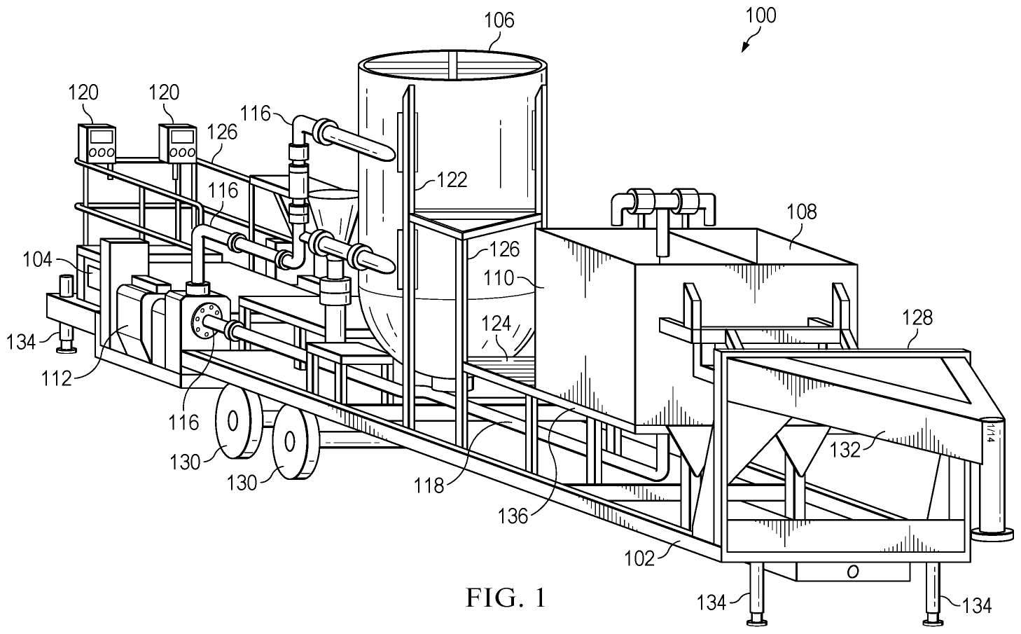

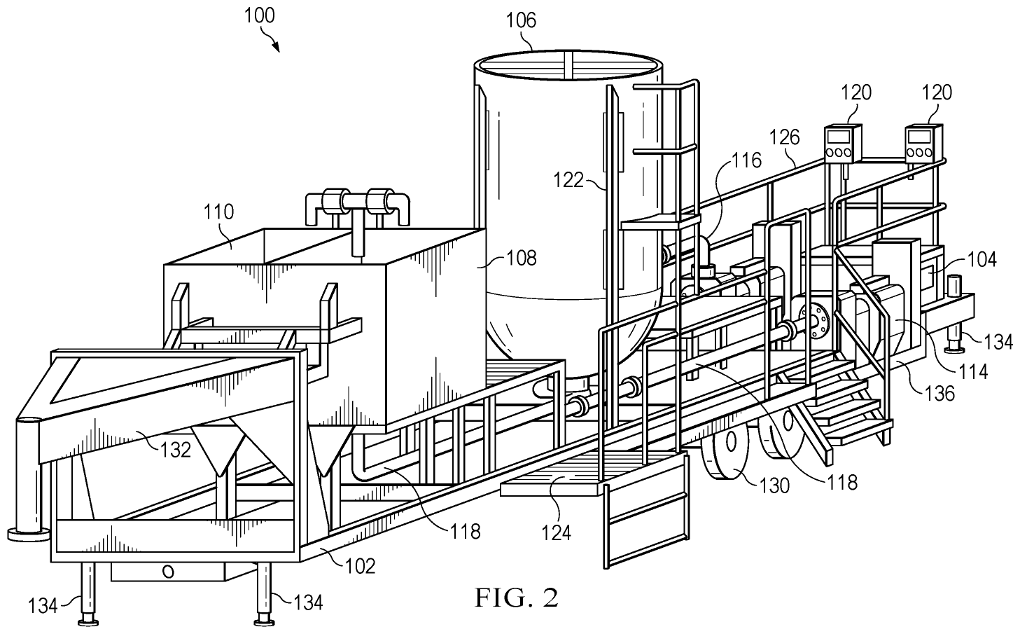

In accordance with exemplary embodiments of the present invention, FIGS. 1 and 2 depict a mobile cement batch mixing plant 100 constructed in accordance with a first embodiment. The mobile cement batch mixing plant 100 can be transported to a wellsite and used to prepare a cement slurry. The cement slurry may be used to line the wellbore for support, seal off sections of the wellbore, or close off petroleum production from the wellbore. As used herein, the term “petroleum” refers broadly to all mineral hydrocarbons, such as crude oil, gas and combinations of oil and gas. The mobile cement batch mixing plant 100 includes a frame 102, which supports a power source 104, a slurry tank 106, a driver displacement tank 108, and a passenger displacement tank 110. The power source 104 powers a slurry pump 112 and a clean pump 114, which are also supported by the frame 102. The pumps 112, 114 pump water and slurry though the plumbing of the mobile cement batch mixing plant 100. The slurry tank 106 is used to prepare the cement slurry by mixing water and dry cement mix via a fluid vortex within the slurry tank 106 and recirculating the cement slurry through the slurry side plumping 116. Water for the cement slurry is held in the driver and passenger displacement tanks 108, 110 and communicated to the slurry tank 106 via the clean side plumping 118. The flow of water and cement slurry through the slurry side plumbing 116 and clean side plumping 118 is controlled via a set of pump controls 120 as well as valves within the slurry side plumbing 116 and clean side plumping 118.

In some embodiments the frame 102 may also include supports for122. As shown in FIGS. 1 and 2, the supports are incorporated into the frame 102 and support the weight of the pumps, tanks, and other components of the mobile cement batch mixing plant 100. The frame 102 may also include platforms 124 and rails 126 which allow operators to access and control the various components of the mobile cement batch mixing plant 100. The platforms 124 and rails 126 may be configured to be removable from the frame 102. In addition, portions of the frame 102 may also be removable. The removal of portions of the frame 102, rails 126 and platforms 124 allows easier access to the mobile cement batch mixing plant 100, such as for repair. Other components of the mobile cement batch mixing plant 100, such as the pumps 112, 114, and tanks 106, 108, 110 may be configured with component skids 136 which allow the components of the mobile cement batch mixing plant 100 to be easily removed from the frame 102. This allows the mobile cement batch mixing plant 100 to be more easily repaired.

Components, platforms, and rails may also be removed from the frame 102 to prepare the mobile cement batch mixing plant 100 for transportation. The transportation of the mobile cement batch mixing plant 100 is effectuated via a transportation apparatus 128 attached to the frame 102. In the present embodiment the transportation apparatus 128 includes a set of wheels 130 and a hitch 132. The wheels 130 and hitch 132 allow the mobile cement batch mixing plant 100 to be attached to a trailer truck and transported between well sites. In other embodiments the transportation apparatus 128 may be comprised of other means to effectuate transportation such as a skid. When the mobile cement batch mixing plant 100 is deposited at a well site the wheels 130 and a series of stabilization jacks 134 contact the ground and support the frame 102. The stabilization jacks 134 can also be used to level the mobile cement batch mixing plant 100 to enable proper operation and mixing of the cement slurry.

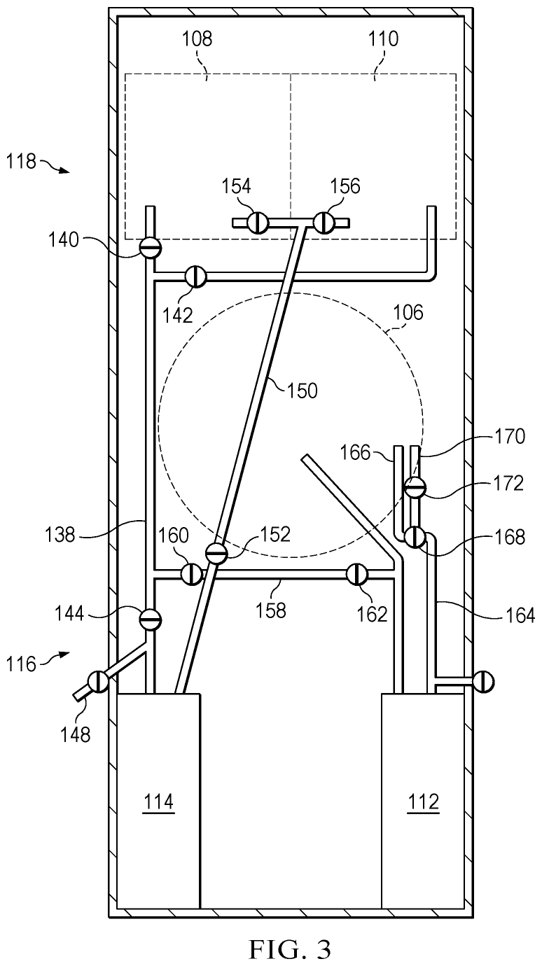

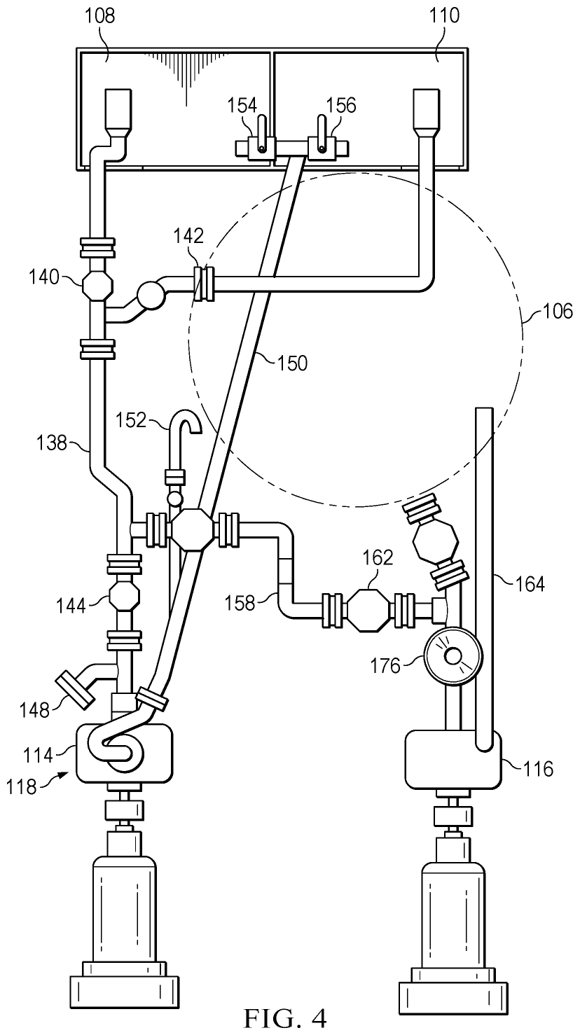

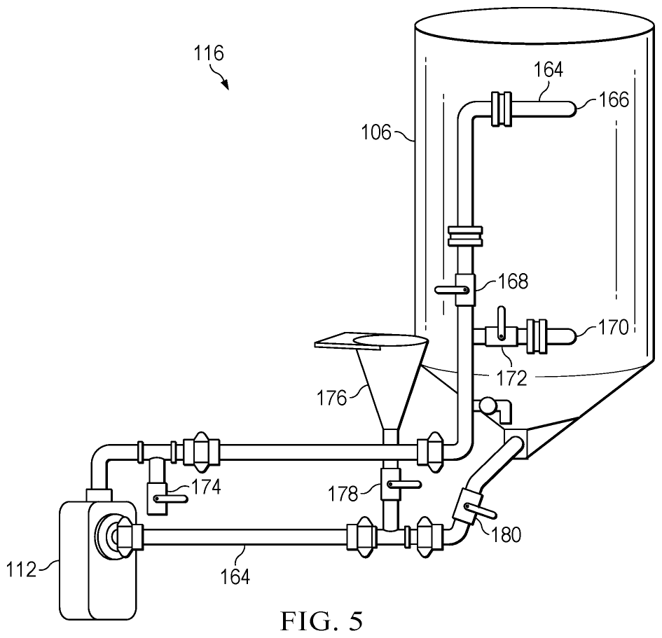

Turning now to FIG. 3 shown therein is a plumbing synopsis of the mobile cement batch mixing plant 100 constructed in accordance with an embodiment of the present invention, showing how the displacement tanks 108, 110 may be connected to the slurry pump 112, clean pump 114, and slurry tank 106. Detailed views of an embodiment of the plumbing systems in the plumbing synopsis of FIG. 3 are shown in FIGS. 4 and 5. In addition to the connections between the above listed components, FIG. 3 also shows a configuration of valves incorporated to control the flow of fluid and to isolate portions of the plumbing.

Beginning with the clean side plumbing 118, as shown in FIG. 3, the displacement tanks 108, 110 are connected to the clean pump 114 via the clean suction supply line 138. The clean suction supply line 138 includes a T-fitting prior to reaching the displacement tanks 108, 110 and connects to each displacement tank 108, 110 independently. The clean suction supply line 138 connection to the driver displacement tank 108 is controlled with a driver isolation valve 140 while the clean suction supply line 138 connection to the passenger displacement tank 110 is controlled with a passenger isolation valve 142. The clean pump 114 can also be isolated from the displacement tanks 108, 110 with the displacement tank suction isolation valve 144.

Water can be loaded into the clean supply suction line 138 and clean side plumbing 118 at the connected fresh water load line 148. Water in the clean side plumbing 118 can also be recirculated back to the displacement tanks 108, 110 via a clean discharge line 150 which runs from the clean pump 114 to the displacement tanks 108, 110. The clean discharge line 150 can also be redirected to the slurry tank 106 for cleaning via a slurry tank clean fill valve 152 or candy cane valve located above the slurry tank 106. Water pumped back to the displacement tanks 108, 110 can be isolated to a specific tank via a driver discharge isolation valve 154 or a passenger discharge isolation valve 156. In this manner the level of water each displacement tank 108, 110 can be controlled and the amount of water sent to the slurry tank 106 can be easily measured.

In addition to providing volume control, the independent displacement tanks 108, 110 in conjunction with the independent slurry pump 112 and clean pump 114 allow for simultaneous slurry mixing and refilling of a displacement tank. This is possible because the plumbing systems allow the two processes to be isolated. Water can be added to the slurry side plumbing through one of the displacement tanks and the slurry pump 112, while the clean pump 114 is used to refill the other displacement tank. Through the clean side plumbing 118, the clean pump can be isolated on the suction side to draw on water to fill either compartment without interrupting the addition of water to the slurry side plumbing 116. This simultaneous interaction is more efficient and as indicated above also allows for accurate fluid displacement tracking.

As shown in FIG. 3, water can be pumped from the clean side plumping 118 to the slurry side plumbing 116 via a clean crossover line 158. The clean crossover line 158 has two isolation valves, a crossover clean isolation valve 160 located closer to the clean supply suction line 138 and a crossover slurry isolation valve 162 located closer to the slurry side plumbing 116. These isolation valves can be used to isolate the clean and slurry side plumbing 118, 116. The clean crossover line 158 connects to the recirculation line 164 of the slurry side plumbing 116. The recirculation line 164 feeds into the slurry pump 112 which pumps fluid to the slurry tank 106.

Fluid or slurry can be pumped into the slurry tank 106 through either an upper tank recirculation port 166 or a lower tank recirculation port 170 in the slurry tank 106. The upper tank recirculation port 166 is located at a position higher on the slurry tank 106 than the lower tank recirculation port 170. The upper port 166 will generally be used when the fluid or slurry levels are higher in the slurry tank 106, while the lower port 170 will be used when the fluid or slurry levels are lower in the slurry tank 106. This selection of ports allows the operator to maintain a vortex and proper mixing when the mobile cement batch mixing plant 100 is in use. The operator can choose which port to recirculate to, generally contingent on fluid volume in slurry tank 106. Each port can be isolated from the recirculation line 164 via a corresponding valve. An upper tank recirculation port valve 168 and a lower tank recirculation port valve 172 allow the operator to control the flow of fluid or slurry into the slurry tank 106. The valves may specifically be trimmed to control the fluid vortex in the slurry tank 106. In other embodiments the slurry tank 106 may have additional or fewer ports. Still in other embodiments multiple ports may be used in conjunction to control the flow of fluid into the slurry tank 106.

Fluid that enters the slurry tank 106 through the recirculation ports 166, 170 returns to the recirculation line 164 via a sump port in the bottom of the slurry tank 106. In the present embodiment the walls of the slurry tank 106 are rounded to aid in the creation of a vortex and sloped to promote the flow of liquid back to the recirculation line 164. Prior to connecting to the slurry pump 112 a slurry flow will pass a hopper feed valve 178, as shown in FIG. 5, connected to the recirculation line 164. The hopper feed valve 178 controls the addition of dry bulk to the recirculation line 164 via a hopper 176 (FIGS. 4 and 5). Once the dry bulk is added to the recirculation line 164 via the hopper 176, the slurry pump 112 pumps the fluid and dry bulk mixture to the slurry tank 106 to be mixed in the vortex and recirculated back to the recirculation line 164. In the present embodiment the hopper 176 is placed in the suction side of the slurry side plumbing 116. This placement utilizes the slurry pump 112 to draw in the dry cement directly into the pump at a high rate which creates shear. In other embodiments the hopper may be placed at other locations along the recirculation line 164.

This method of introducing dry cement into the system reduces the time to mix dry cement product into a viable cement slurry dramatically. The recirculation process described above continues until the slurry mixture is properly mixed and ready to be deployed. When the cement slurry is ready to be deployed, the slurry discharge 174 can be opened and the slurry can be pumped into the wellbore or to another desired location. In the present embodiment a slurry discharge 174 is connected to the recirculation line 164 between the slurry tank 106 and recirculation port valves 168, 172. In some embodiments the slurry discharge 174 is connected to a high pressure pump which will control the flow of slurry from the mobile batch cement mixing plant 100.

FIGS. 4 and 5 shows detailed views of the plumbing system of the mobile cement batch mixing plant 100. FIG. 4 shows an embodiment of a plumbing system of the mobile cement batch mixing plant. FIG. 5. shows the slurry side plumbing 116 system independent of the mobile cement batch mixing plant 100. In FIG. 5 dimensions are shown to illustrate an embodiment of the invention. In the present embodiment, the increased mixing efficiency of the mobile cement batch mixing plant 100 described above is able to introduce at least 94 pounds of Class C cement into the recirculation system in 17 seconds. As shown in FIG. 5 the mobile cement batch mixing plant 100 has been fitted with plumbing on the slurry side plumbing 116. This plumbing may be 4″ plumbing and may be coupled with a 6×6 slurry pump 112 to aid in a friction reduction to keep the slurry from heating up and thereby avoid flash setting the cement slurry batch. In other embodiments other dimensions may be used to achieve similar results.

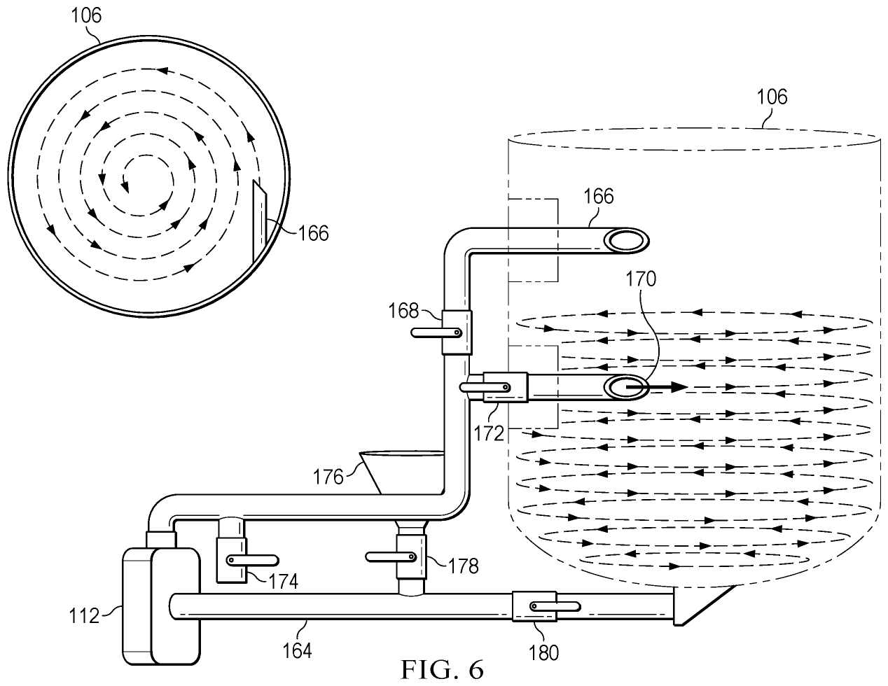

Turning now to FIG. 6 the slurry tank 106 and attached slurry side plumbing 116 with a fluid vortex in the slurry tank 106 induced by recirculation of a fluid slurry is shown. In FIG. 6, a slurry suction valve 180 is shown incorporated into the recirculation line between the slurry tank 106 and the slurry pump 112. The slurry tank 106 utilizes a cylindrical mixing tank to aid in the creation of a fluid vortex within the slurry tank 106. The recirculation ports 166, 170 on the side of the slurry tank 106 are placed at an angle to induce the flow of fluid along the interior wall of the slurry tank 106 which also aids in the creation of a fluid vortex. These two characteristics of the slurry tank 106 along with the velocity of the fluid flow added by the slurry pump 112, cause the fluid to circle the interior of the tank at a high rate and create a fluid vortex. The fluid vortex mixes the dry bulk and water and removes the need for a mechanical agitator. In some embodiments the sump of the slurry tank 106 is also angled to incorporate the angle of flow and velocity of the vortex down into the recirculation line 164 toward the slurry pump 112.

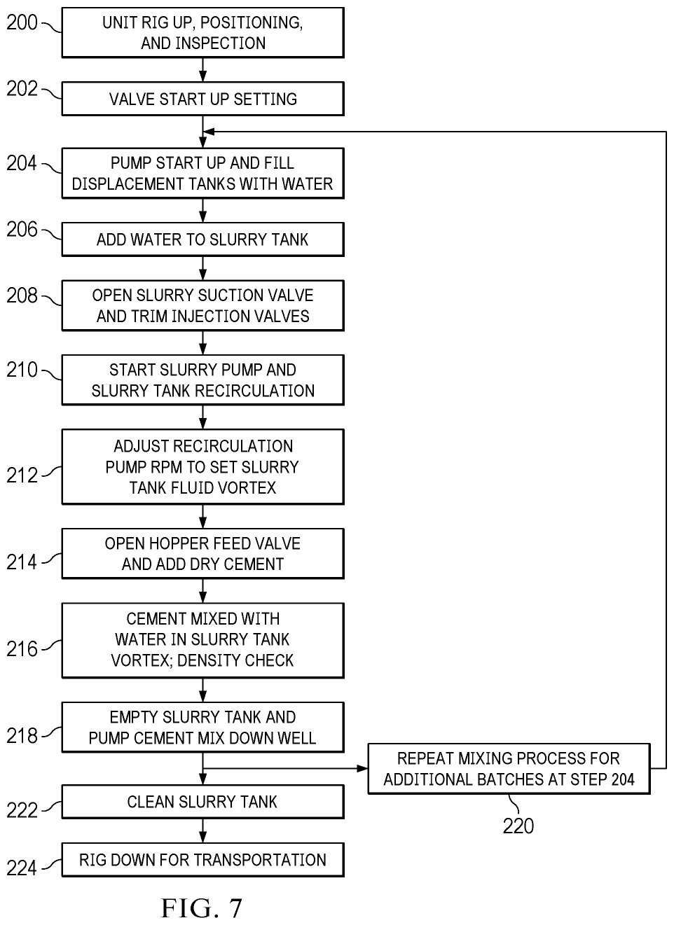

Turning now to FIG. 7 shown therein is a process for mixing a cement slurry with a mobile cement batch mixing plant 100 constructed in accordance with an embodiment of the present invention. Beginning with step 200, the mobile cement batch mixing plant 100 starts the rig up process wherein the unit is spotted for optimal positioning on location. Stabilizing jacks 134 are then lowered and removable platforms 124, rails 126 and portions of the frame 102 are installed onto the mobile cement batch mixing plant 100. Suction and discharge hoses are then connected to the mobile cement batch mixing plant 100 and inspected. Fluid levels within the mobile cement batch mixing plant 100 are also checked during the rig up process. After rig up, the process proceeds to step 202 wherein the valves are set for pump start up. In the present embodiment, step 202 includes isolating the slurry side plumbing 116, closing the displacement tank suction isolation valve 144 and opening the driver and passenger discharge isolation valves 154, 156. The process can then proceed to step 204 wherein the clean pump 114 is started and the displacement tanks 108, 110 are filled. Then in step 206 the slurry tank 106 can be filled via the slurry tank clean fill 152 or candy cane valve to the desired level. Once the slurry tank 106 is filled, the clean pump 114 can be disengaged and the slurry tank clean fill 152 can be closed.

Once the tanks are filled, the process can proceed to step 208 wherein the slurry suction valve 180 is opened and fluid communication in the recirculation line 164 is opened to the recirculation port valves 168, 172. A recirculation port valve can then be opened depending on the fluid level in the slurry tank 106. In the present embodiment, if the fluid volume is less than 15 barrels, the lower port valve 172 would be opened and the upper port valve 168 would be closed. If the fluid volume is over 15 barrels, the upper port valve 168 would be opened and the lower port valve 172 would be closed. In other embodiments, different slurry tank 106 volumes may correspond with different valve settings. Once the port valves are trimmed, the process proceeds to step 210 wherein the slurry pump 112 is engaged and recirculation through the recirculation line 164 and slurry tank 106 begins. In step 212, the rpm of the slurry pump 112 can be manipulated through the pump controls 120 to achieve the desired fluid vortex in the slurry tank 106 and the system is ready for the addition of dry cement.

In step 214, a set amount of dry cement corresponding to the fluid present in the slurry tank 106 and recirculation line 164 is added to the hopper 176. The cement then moves through an opened hopper feed valve 178 into the recirculation line 164. In step 216, the cement and water are then pumped into the slurry tank 106 and mixed by the fluid vortex and recirculated. Once sufficient mixing has occurred a sample of the cement slurry can be removed from the system and checked for the appropriate density. If the cement slurry density is appropriate, then in step 218 the slurry discharge 174 can be opened and the slurry can be pumped to a desired location. After the cement slurry has been pumped out of the slurry tank 106 and recirculation line 164 additional batches can be prepared by proceeding to step 220 wherein the slurry discharge 174 is closed, the slurry pump 112 is stopped and the process of mixing begins again by adding water to the slurry tank 106 and displacement tanks 108, 110. This begins the process at step 204.

Alternatively, after the cement slurry has been pumped out to the desired location, the process can proceed to step 222 wherein the slurry tank 106 is cleaned. This process begins with closing the slurry discharge 174 and stopping the slurry pump 112. The crossover valves 160, 162 are then opened to allow water to flow into the slurry side plumbing 116 from the clean side plumbing 118. The slurry pump 112 can then be restarted which will draw water out of the driver displacement tank 108, provided that the driver isolation valve 140 is opened and the passenger isolation valve 142 is closed. When the driver displacement tank 108 is emptied, the driver isolation valve 140 can be closed and the passenger isolation valve 142 can be opened. This allows the slurry plump 112 to continue to pull clean water into the slurry side plumbing 116.

While the passenger displacement tank 110 is being emptied, the driver displacement tank 108 can be refilled through the clean discharge line 150, driver discharge isolation valve 154 and the clean pump 114. When the desired volumes are reached the slurry pump 112 and clean pump 114 can be stopped. The slurry side plumbing 116 can then be isolated via the crossover valves 160, 162 and additional water can be added to the slurry tank 106 via the slurry tank clean fill 152 or candy cane valve. The isolated slurry side plumbing 116 can then recirculate the clean water added to the slurry side plumbing 116 with the slurry side pump 112 to remove any cement slurry from the system through recirculating the clean water.

When the system is has circulated enough water to remove the slurry, the slurry discharge 174 can be opened and the water slurry waste can be pumped to a cleanup pit. If desired, additional water from the displacement tanks 108, 110 can be flushed through the system by opening the crossover valves 160, 162 and driver and passenger isolation valves 140, 142, and engaging the clean pump 114. After the system has been flushed of water and slurry the process can proceed to step 224. In step 224, the mobile cement batch mixing plant 100 is rigged down. Components such as the rails 126, platforms 124 which can be removed for transportation are removed and hoses are disconnected from the system. Stabilizing jacks 134 are raised and the transportation apparatus is otherwise prepared for transport. In addition the entire mobile cement batch mixing plant 100 is checked for roadworthiness.

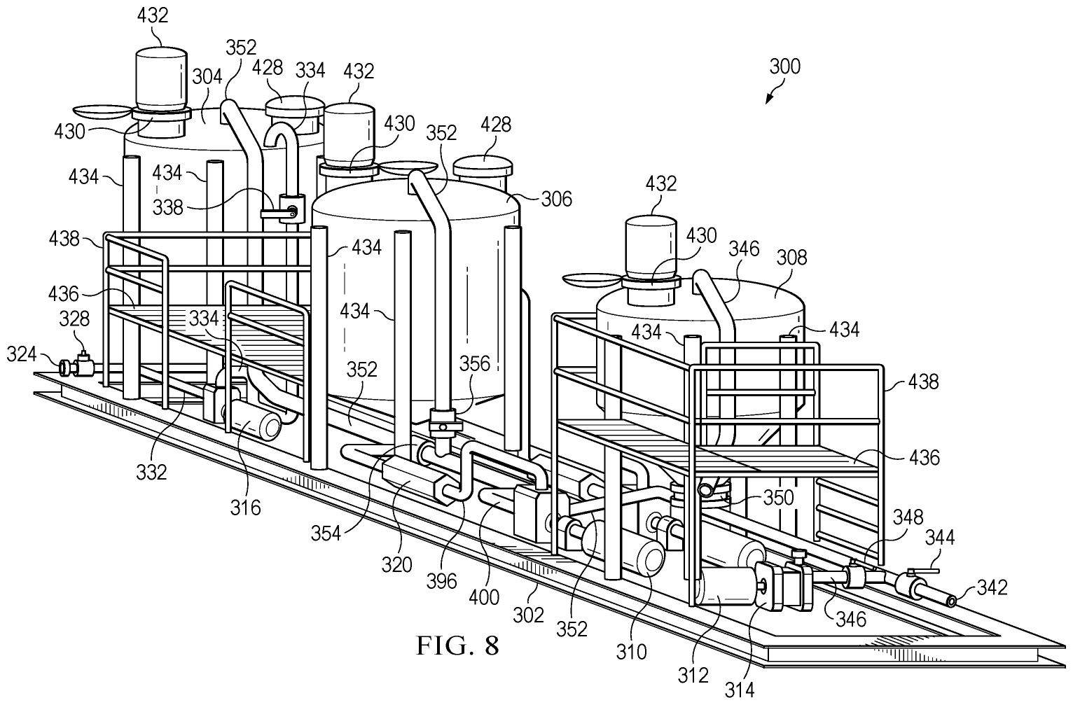

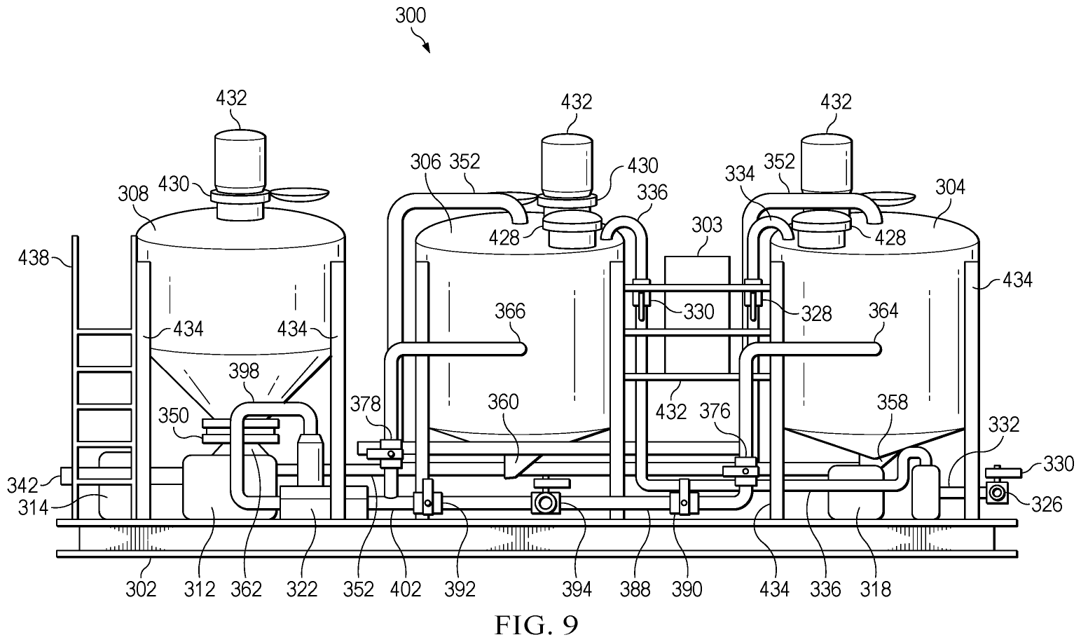

In accordance with exemplary embodiments of the present invention, FIGS. 8 and 9 depict a mobile cement batch mixing plant 300 constructed in accordance with a second embodiment. Similar to the mobile cement batch mixing plant 100, the mobile cement batch mixing plant 300 can be transported to a wellsite and used to prepare a cement slurry. The cement slurry may be used to line the wellbore for support, seal off sections of the wellbore, or close off petroleum production from the wellbore. The mobile cement batch mixing plant 300 includes a frame 302, a control unit 303, a first slurry tank 304, a second slurry tank 306, and a cement storage tank 308. While two slurry tanks and one cement storage tank are depicted, it will be understood that one slurry tank may be used, more than two slurry tanks may be used, and more than one cement storage tank may be used as desired. It will be understood that equipping the mobile cement batch mixing plant 300 with multiple slurry tanks and associated pumping components provides additional redundancy and backup. The cement storage tank 300 may be optimally sized to old at least 5,000 lbs of bulk storage, however, other sizes may be used as desired.

Although not depicted in FIGS. 8 and 9, the frame 302 may optionally be configured with transportation mechanisms, such as wheels and a hitch, or a skid like that of frame 102 of the mobile cement batch mixing plant 100. Additionally, it will be understood that stabilization jacks, legs, wheels, supports, and the like may be used to support the frame 302 during operation of the mobile cement batch mixing plant 300. Additionally, the frame 302 may also include platforms 436 and rails 438 which allow operators to access and control the various components of the mobile cement batch mixing plant 300. The platforms 436 and rails 438 may be configured to be removable from the frame 302. In addition, portions of the frame 302 may also be removable. The removal of portions of the frame 302, rails 438 and platforms 436 allows easier access to the mobile cement batch mixing plant 300, such as for repair.

Although not depicted, it will be understood that other components of the mobile cement batch mixing plant 300, as further described below, may be configured with component skids to allow each component of the mobile cement batch mixing plant 300 to be easily removed from the frame 302. This allows the mobile cement batch mixing plant 300 to quickly continue operation upon breakdown by switching faulty components. Components, platforms, and rails may also be removed from the frame 302 to prepare the mobile cement batch mixing plant 300 for transportation.

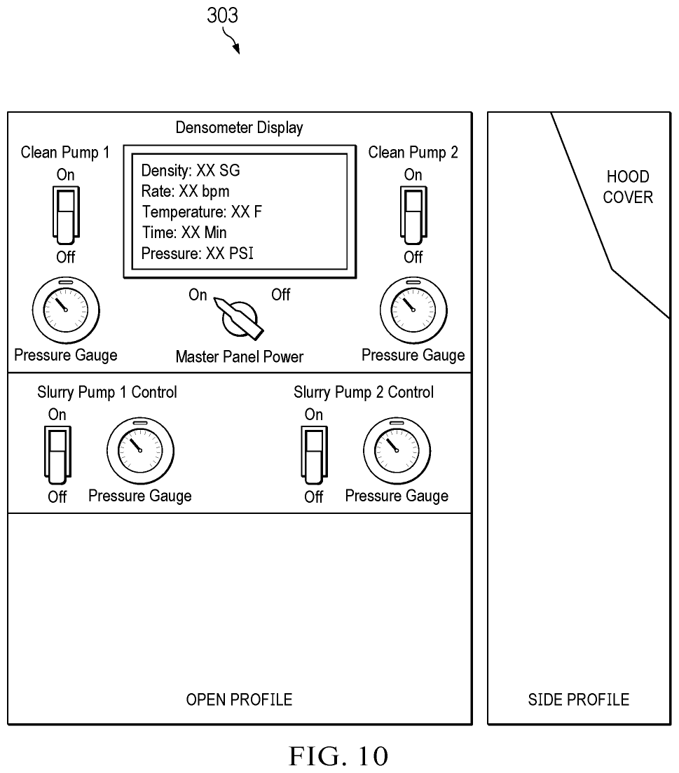

The mobile cement batch mixing plant 300 also may include a first a first slurry pump 310, a second slurry pump 312, a pneumatic pump 314, a first clean pump 316, and a second clean pump 318. The plant 300 may also include a first densometer 320 and a second densometer 322. The pneumatic pump 314 may be a 25 hp screw style pump capable of pumping air into the system at a 9-13 psi range or alternatively with a range of 6-8 cu/ft (600-800 lbs.) a minute; however, it will be understood that other styles of pneumatic pumps and other sizes or hp ranges may be used. Preferably, the clean pumps 318, 320 are 3×3 transfer pumps, and the slurry pumps 310, 312 are 6×6 centrifugal pump; however, it will be understood that other sizes and types of pumps may be used for optimizing the flow of the liquids it the system. Additional pumps and densometers may be added as need to improve the circulation of the plumbing system, or as needed for additional slurry tanks or concrete tanks. The various pumps and densometers are powered and controlled by the control unit 303. An exemplary depiction of the control unit 303 is included in FIG. 10.

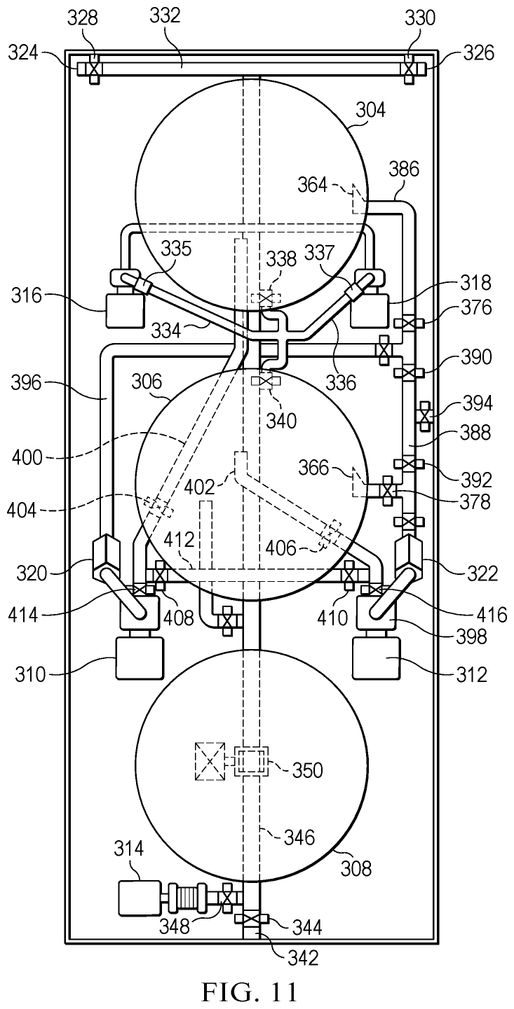

As depicted in FIGS. 8, 9, and 11, the mobile cement batch mixing plant 300 includes a first water intake 324 and a second water intake 326 located on opposite sides of the frame 302 to allow water lines delivering water to be connected on either side of the plant 300. A first water intake valve 328 and a second water intake valve 330 are provided to allow either water intake 324, 326 to be used or to kill flow on one side or the other. It will be understood that additional intakes for water or other liquids may be used, or a single intake may be used as desired and may be located anywhere on the frame 302 as desired to provide easy hookup and distribution of the water. When water enters through one of the intake valves 328, 330 it flows into a clean water suction line 332. The water then enters the first clean pump 316 and/or the second clean pump 318. The water may be controlled via additional valves so that water only enters one of the clean pumps 316, 318.

After entering the first clean pump 314 and/or the second clean pump 316, the pumps may be used to selectively pump clean water into a first clean pump discharge line 334 and a second clean pump discharge line 336. A first clean pump isolation valve 335 and a second clean pump isolation valve 337 may be used to cut off water at the first clean pump 314 or second clean pump 316 respectively. A first clean pump discharge valve 338 and a second clean pump discharge valve 340 may also be used to control the flow of water into the first clean pump discharge line 334 and second clean pump discharge line 336 before the water reaches the first slurry tank 304 and/or second slurry tank 306 respectively.

The first slurry tank 304 and second slurry tank 306 may be configured to include an observation hatch 428 which may be opened while water is being pumped into the slurry tanks 304, 306. Although not depicted, the slurry tanks 304, 306 may include measurement lines inside the tank to allow a particular volume of water to be added. Once the required amount of water has been pumped into the slurry tanks, the observation hatch 428 may be closed.

After adding the desired amount of water to the slurry tanks 304, 306, the first slurry pump 310 and/or second slurry pump 312 are engaged to start recirculation of the fluid in the slurry tanks 304, 306. In particular, the first slurry tank 304 has a first sump 358 and the second slurry tank 306 has a second sump 360, each located at the bottom of the respective slurry tanks. Each of the sumps 358, 360 are angled to incorporate the angle of flow and velocity down into the suction side of the piping and back to the respective slurry pump 310, 312. Preferably each of the sumps 358, 360 are trough sumps and are preferably 10 degrees offset from the center of each slurry tank 304, 306. It will be understood that the sumps 358, 360 could be at different locations from the center of the slurry tanks 304, 306, including a range from 0 to 35 degrees. The sumps 358, 360 are also preferably angled downward at 15 degrees. However, different downward angles could be used including angles in a range from 0 up to 60 degrees.

The first slurry pump 310 may be engaged to draw water through the first sump 358 into a first suction line 400 and into the first slurry pump 310. The water is then discharged from the first slurry pump 310 into a first discharge line 396, then into a first recirculation line 386, through a first recirculation port 364, and back into the first slurry tank 304. The second slurry pump 312 may be engaged to draw water through the second sump 360 into a second suction line 402 and into the second slurry pump 312. The water is then discharged from the second slurry pump 312 into a second discharge line 398, then into a second recirculation line 388, through a second recirculation port 366, and back into the second slurry tank 306. Each of these processes may be commenced simultaneously or alternatively.

The recirculation ports 364, 366 are placed on the sides of the slurry tanks 304, 306 and are angled to induce the flow of fluid along the interior wall of the slurry tanks. In particular, the recirculation ports 364, 366 preferably enter the side of the slurry tanks 304, 306 at a 90 degree angle with a mule shoe angle cut to match the curvature of the slurry tanks 304, 306. It will be understood that the angles used could range from 0 to 20 degrees or from 120 to 180 degrees. The cylindrical shape of the slurry tanks 304, 306 also assist in moving the water within the tanks. Additionally, the slurry pumps 310, 312 may be set to operate at a specific RPM/velocity to optimize the flow and velocity of the water being recirculated through the plumbing system. The fluid dynamics on the inside of the slurry tanks 304, 306 create a high velocity fluid vortex within the slurry tanks. These features eliminate the need for a mechanical agitator or other device typically needed in prior art systems to keep the fluid moving.

Once the desired fluid vortex of the water has been established, a bag hatch 430 located on each of the slurry tanks 304, 306 is opened and a micron bag 432 may be secured. Next, the slurry side of the mobile cement batch mixing plant 300 may be engaged to add cement into the slurry tanks. The cement storage tank 308 is equipped to hold a dry cement product, which may be released into the system by trimming open or closed an electric slide gate valve 350 at the bottom of the tank. The pneumatic pump 314 may be utilized to blow air through an air line 346 and push the cement product into and through a feed line 352 to deliver it to the slurry tanks 304, 306. Once air from the pneumatic pump 314 is induced into the first and/or second slurry tanks 304, 306, the micron bag 432 inflates allowing air to escape while keeping silica from entering the atmosphere outside of the slurry tanks. It will be understood that additional bag hatches like that of bag hatch 430 and additional micron bags like that of micron bag 432 may be installed as needed to ensure enough air is released from the system and to ensure that the environment is protected from silica contamination.

The feed line 352 may include a first feed valve 354, located on the feed line 352 going into the first slurry tank 304, and a second feed valve 356, located on the feed line 352 going into the second slurry tank 306. Each of the feed valves 354, 356 may be opened or closed to control whether the dry cement product is delivered to the first slurry tank 304 and the second slurry tank 306 simultaneously, or to just one of the slurry tanks, 304, 306. Additionally, the feed valves 354, 356 may be used to control the amount of dry cement product entering the slurry tanks 304, 306. It will be understood that the plant 300 is equipped to be capable of moving up to 800 lbs of cement a minute.

Alternatively to the pneumatic pump 314, dry cement may be introduced through an auxiliary line 342 from an offboard bulk storage blower system (not depicted). If the auxiliary line 342 is used, a pneumatic pump isolation valve 348 may be used to close off the air line to the pneumatic pump 314. If the pneumatic pump 314 is used, an auxiliary valve 344 may be used to close off the auxiliary line 342.

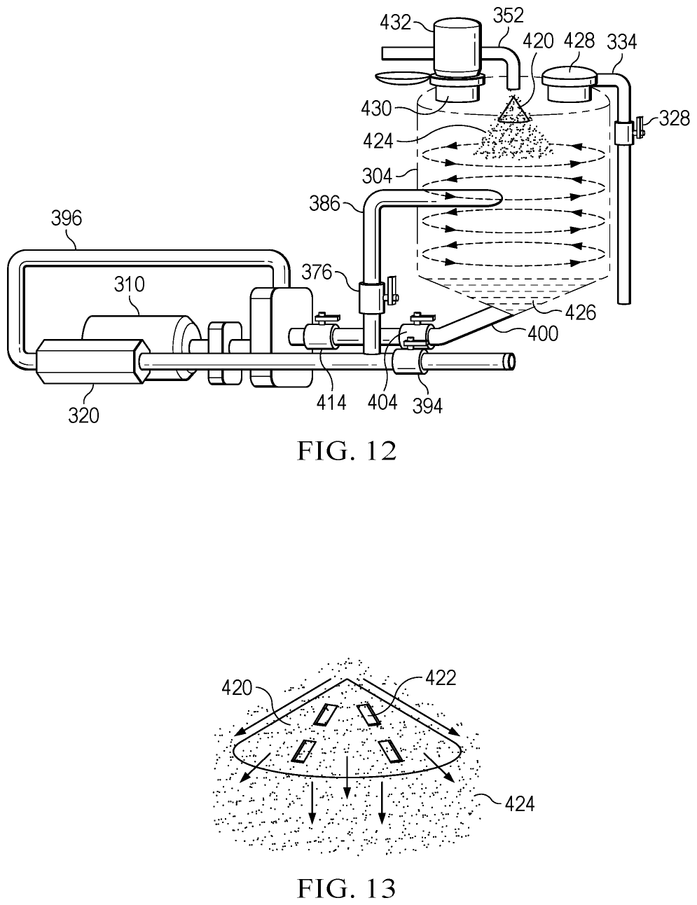

As depicted in FIGS. 12 and 13, the dry cement, shown as 424, is inducted through the feed line 352 and then through a dispersing cone 420 inside the respective slurry tank 304 or 306. The dispersing cone 420 may include several slots 422 to allow the dry cement 424 to fan in a 360-degree span into the higher velocity points within the fluid vortex. This mitigates clumping issues and helps the dry cement 424 mix with the water efficiently. The dispersing cone 420 is conical shaped and preferably sized to be 6″×6″, however, it will be understood that other sizes may be used to optimize the disbursement of the dry cement 424 into the respective slurry tanks 304, 306.

While the dry cement 424 is being mixed with the water in the slurry tanks 304, 306, the newly created slurry mixture 426 is still being circulated through the system to maintain the fluid vortex within the slurry tanks 304, 306. The slurry mixture 426 passes through the first sump 358 into the first suction line 400 and into the first slurry pump 310. The slurry mixture 426 is then discharged from the first slurry pump 310 into the first discharge line 396, through the first densometer 320, then into the first recirculation line 386, through the first recirculation port 364, and back into the first slurry tank 304.

The second slurry pump 312 may be engaged to draw the slurry mixture 426 through the second sump 360 into the second suction line 402 and into the second slurry pump 312. The slurry mixture 426 is then discharged from the second slurry pump 312 into the second discharge line 398, then into the second recirculation line 388, through the second densometer 322, through the second recirculation port 366, and back into the second slurry tank 306.

It will be understood that the various valves described herein may be trimmed allowing either slurry pump 310, 312 to mix either slurry tank 304, 306 in the event of a pump failure. In normal operations, the system can be used by alternating slurry tanks or by simultaneously mixing both slurry tanks 304, 306. During recirculation, the density of the slurry mixture 426 in each slurry tank 304, 306 may be constantly measured via the densometers 320, 322 and displayed on the control unit 303 to determine when the target density is reached.

Once the target density of the slurry mixture 426 has been reached, the pneumatic pump 314 or the auxiliary line 342 blower system will be turned off to stop dry cement from being blown into the slurry tanks 304, 306. A sample can then be taken of the slurry mixture 426 to verify target density with a pressurized mud scale to ensure that the target density has been achieved.

After verification of the target density, a first slurry discharge valve 390 and an offboard discharge valve 394 may be opened, and an offboard high pressure pump (not depicted) may be used to draw the slurry mixture 426 out of the first slurry tank 304 and down into the well. Additionally, a second slurry discharge valve 392 and the offboard discharge valve 394 may be opened to allow the offboard high pressure pump to draw the slurry mixture 426 out of the second slurry tank 306 and down into the well.

Once the slurry mixture 426 has been pumped off board, the observation hatch 428 may be opened and water may be drawn into the respective slurry tanks 304, 306 to displace the slurry mixture 426 to either clean out the systems or add the desired volume of water to mix the next cement slurry mixture batch. After the operation has been completed and the system has been cleaned and emptied, the observation hatch 428 and bag hatch 430 are closed and secured to prepare for transit of the mobile cement batch mixing plant 300. Additionally, the micron bag 432 is stored to keep it clean and dry.

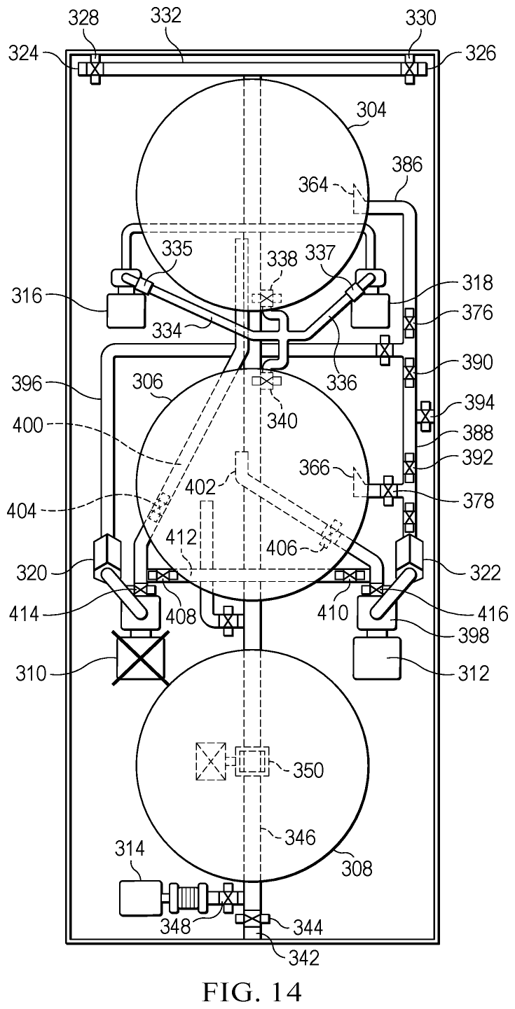

Turning now to FIG. 14, it will be understood that if one of the slurry pumps 310, 312 fails, the valves may be trimmed to recirculate the fluid (water or slurry mixture) through the working slurry pump. For example, if the first slurry pump 310 fails, a first suction isolation valve 404, a first cross over isolation valve 408, a second cross over isolation valve 410, a second slurry pump isolation valve 416, the second slurry discharge valve 392, the first slurry discharge valve 390, and the recirculation valve 376 may be trimmed open. Also, the off board discharge valve 394, the recirculation valve 378, the second suction isolation valve 406, and the first slurry pump isolation valve 416 may be trimmed closed. Trimming the valves in this way allows fluid to flow and recirculate from the first slurry tank 304 through the second slurry pump 312 and back into the first slurry tank 304 and prevents fluid from traveling through the first slurry pump 310. A similar process may be used if the second slurry pump 312 fails.

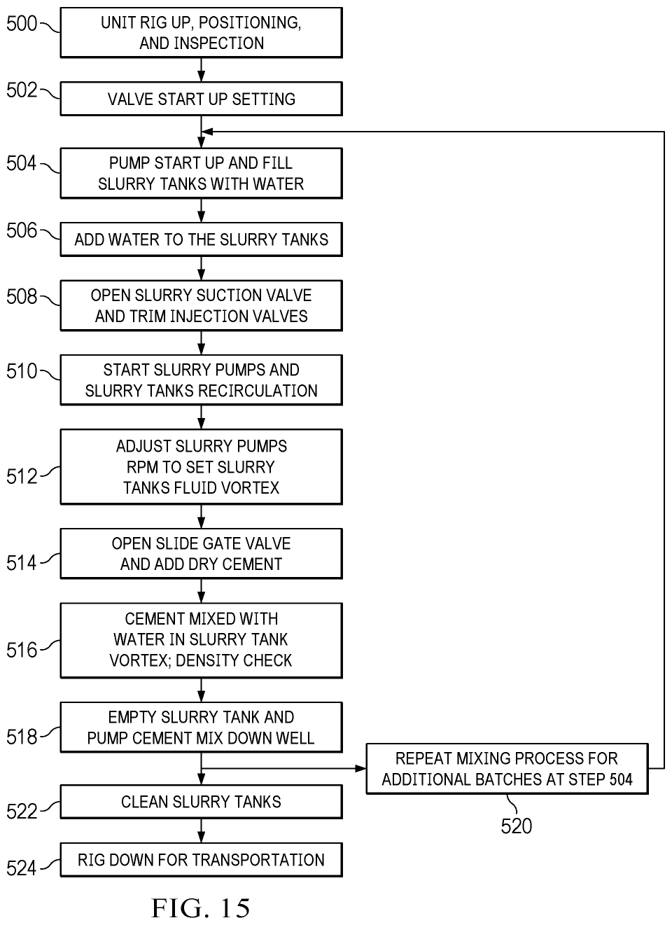

Turning now to FIG. 15 shown therein is a process for mixing a cement slurry with a mobile cement batch mixing plant 300 constructed in accordance with an embodiment of the present invention. Beginning with step 500, the mobile cement batch mixing plant 300 starts the rig up process wherein the unit is spotted for optimal positioning on location. Stabilizing jacks 134 are lowered and removable platforms 436, rails 438 and portions of the frame 302 are installed onto the mobile cement batch mixing plant 300. Suction and discharge hoses are then connected to the mobile cement batch mixing plant 300 and inspected. Fluid levels within the mobile cement batch mixing plant 300 are also checked during the rig up process. After rig up, the process proceeds to step 502 wherein the valves are set for pump start up. In the present embodiment step 502 includes isolating the slurry side plumbing by closing the first suction isolation valve 404 and second suction isolation valve 406 and opening the first water intake valve 328 and the second water intake valve 330. The process can then proceed to step 504 wherein the first clean pump 316 and the second clean pump 318 are started and the slurry tanks 304, 306 are filled with water. Once the slurry tanks 304, 306 are filled, the clean pumps 316, 318 can be disengaged and the water intake valves 328, 330 can be closed.

Once the tanks are filled, the process can proceed to step 208 wherein the first suction isolation valve 404 and second suction isolation valve 406 are opened and fluid communication in the first recirculation line 386 and second recirculation line 388 are opened to the recirculation valves 376, 378. The process proceeds to step 510 wherein the slurry pumps 310, 312 are engaged and recirculation through the recirculation lines 386, 388 and slurry tanks 304, 306 begins. In step 512 the RPM of the slurry pumps 310, 312 may be manipulated through the control unit 303 to achieve the desired fluid vortex in the slurry tanks 304, 306 and the system is ready for the addition of dry cement.

In step 514, the pneumatic pump 314 or auxiliary line 342 are activated to push air into the system and the electronic slide gate valve 350 of the cement tank 308 is trimmed open to allow dry cement to move into the feed line 351 and into the slurry tanks 304, 306 through the disbursement cone 420. In step 516 the cement and water are then mixed by the fluid vortex and recirculated. Once sufficient mixing has occurred a sample of the cement slurry can be removed from the system and checked for the appropriate density. If the cement slurry density is appropriate, then in step 518 the slurry discharge valves 390, 392 may be opened and the slurry can be pumped to a desired location, such as down the well. After the cement slurry has been pumped out of the slurry tanks 304, 306 additional batches can be prepared by proceeding to step 520 wherein the slurry discharge valves 390, 392 are closed, the slurry pumps 310, 312 are stopped and the process of mixing begins again by adding water to the slurry tanks 304, 306 in step 504.

Alternatively, after the cement slurry has been pumped out to the desired location, the process can proceed to step 522 wherein the slurry tanks 304, 306 are cleaned. This process begins with closing the slurry discharge valves 390, 392 and stopping the slurry pumps 310, 312. The first clean pump 316 and the second clean pump 318 are started and the slurry tanks 304, 306 are filled with water and water is recirculated through the system and tanks for cleaning and flushing.

After the system has been flushed of water and slurry, the process can proceed to step 524, wherein the mobile cement batch mixing plant 300 is rigged down. Components such as the rails 438, platforms 436, and other items which can be removed for transportation are removed, the observation hatch 428 and bag hatch 430 are closed, and hoses are disconnected from the system.

From the above description, it is clear that the inventive concepts disclosed herein is well adapted to carry out the objects and to attain the advantages mentioned and those inherent in the inventive concepts disclosed herein. While preferred embodiments of the inventive concepts disclosed have been described for this disclosure, it will be understood that numerous changes may be made which will readily suggest themselves to those skilled in the art and which are accomplished within the scope and coverage of the inventive concepts disclosed and claimed herein.

It is claimed:

1. A method for mixing a cement slurry with a mobile cement batch mixing plant, the method comprising the steps of:
pumping water to a cylindrical slurry tank that includes a cylindrical upper portion, a conical lower portion, and a closed top that together define a slurry tank interior;
recirculating the water from the conical lower portion, through a recirculation pump, and into the cylindrical upper portion through a tangential nozzle in the cylindrical upper portion to induce a vortex within the slurry tank interior;
adding a continuous stream of a powdered cement from the closed top into the vortex within the slurry tank interior to create a cement slurry;
recirculating the cement slurry from the conical lower portion, through a recirculation pump, and into the cylindrical upper portion, wherein the vortex is maintained within the slurry tank while the powdered cement is being added and the cement slurry is recirculating; and
measuring a density of the recirculating cement slurry while the powdered cement is being added until a desired density of the cement slurry is reached.

2. The method of claim 1, wherein the conical lower portion is a trough sump.

3. The method of claim 2, wherein the trough sump is angled downward to induce a desired flow and a desired velocity for the recirculating cement slurry.

4. The method of claim 3, wherein the trough sump is angled downward at 15 degrees.

5. The method of claim 2, wherein the trough sump is offset from a center of the cylindrical slurry tank.

6. The method of claim 2, wherein the trough sump is offset 10 degrees from a center of the cylindrical slurry tank.

7. The method of claim 1, wherein the cement slurry enters the cylindrical upper portion through a recirculation port, wherein the recirculation port is angled to match a curvature of the cylindrical upper portion to induce the vortex along the interior of the slurry tank.

8. The method of claim 7, wherein the recirculation port enters the cylindrical upper portion at a 90 degree angle.

9. The method of claim 1, wherein the step of pumping water to the cylindrical slurry tank further includes the step of controlling the water flowing to the cylindrical slurry tank through the use of at least one intake valve and at least one intake pump.

10. The method of claim 1, wherein the vortex may be adjusted by adjusting the recirculation pump to a specific velocity.

11. The method of claim 1, wherein the step of adding a continuous stream of the powdered cement further includes the step of:
opening an electric slide gate valve at a bottom of a cement storage tank; and
blowing air through an air line using a pneumatic pump, wherein the air pushes the powdered cement through a feed line to the slurry tank.

12. The method of claim 1, wherein the closed top of the slurry tank includes a dispersing cone, wherein the dispersing cone includes more than one slots through which the powdered cement is added to the vortex.

13. The method of claim 1, wherein the mobile cement batch mixing plant includes a frame for transporting the mobile cement batch mixing plant.
